(19) United States
(12) Patent Application Publication
(10) Pub. No.: US 2023/0309568 A1
(43) Pub. Date: Oct. 5, 2023

(54) CUTTING TOOL

(71) Applicant: Signature Flatbreads (UK) LTD, Dunstable, Bedfordshire (GB)

(72) Inventors: Matthew PURNELL, Bedfordshire (GB); William EID, Bedfordshire (GB)

(21) Appl. No.: 18/021,569

(22) PCT Filed: Aug. 16, 2021
(86) PCT No.: PCT/GB2021/052122

§ 371 Date: Feb. 16, 2023

(30) Foreign Application Priority Data
Aug. 17, 2020 (GB) 2012827.8

(51) Int. Cl. A21C 11/04

(52) U.S. Cl. CPC A21C 11/04

(57) ABSTRACT

A cutting tool for an apparatus for cutting a sheet of dough, the cutting tool comprising: a support member having a plurality of apertures extending therethrough; and a plurality of cutting elements supported by the support member, each cutting element comprising a cutting edge extending away from the support member and defining a closed shape, wherein the cutting edges of adjacent cutting elements meet to define discrete cavities between the cutting edges of adjacent cutting elements; and wherein each of the discrete cavities is in communication with at least one of the apertures in the support member to define a waste dough extraction path.

### TECHNICAL FIELD

The present disclosure relates to a cutting tool for an apparatus for cutting a sheet of dough, an apparatus for cutting a sheet of dough and a method of cutting a sheet of dough.

### BACKGROUND

Food items such as flatbreads can be cut from a sheet of dough by a cutting tool. As flatbreads are typically non-tessellating shapes, a continuous sheet of waste dough remains between each cut flatbread. This waste dough is typically removed from the cut flatbreads by conveying it away from the main production line. As the waste dough is a continuous sheet it is continuously pulled away from the main production line as the rest of the sheet is cut. This method can result in a significant amount of wastage. There remains a need for developments in this field.

### SUMMARY OF THE INVENTION

According to the present disclosure there is provided a cutting tool for an apparatus for cutting a sheet of dough, the cutting tool comprising: a support member having a plurality of apertures extending therethrough; and a plurality of cutting elements supported by the support member, each cutting element comprising a cutting edge extending away from the support member and defining a closed shape, wherein the cutting edges of adjacent cutting elements meet to define discrete cavities between the cutting edges of adjacent cutting elements; and wherein each of the discrete cavities is in communication with at least one of the apertures in the support member to define a waste dough extraction path.

Each cutting element may further comprise a base and the cutting edges may extend from the respective base.

Each cutting edge may extend around a perimeter of the respective base.

The base and the cutting edges may together define a pocket in the cutting element, wherein the base may be configured to prevent communication between the apertures in the support member and the pocket of the cutting elements.

Adjacent cutting elements may share a portion of the cutting edge such that the cutting edge of each cutting element may comprise a consistent thickness.

The cutting elements may be of an equal size and shape to each other. The cutting elements may be elliptical in shape. Furthermore, the cutting elements may be integral such that all the cutting elements may be formed from a single piece. Alternatively, each cutting element may be a separate element. In some embodiments at least two adjacent cutting elements may be formed integrally as first group and may be coupled to at least one further cutting element.

The support member may comprise an outer wall at least partially surrounding a hollow space, the plurality of apertures may extend through the outer wall such that each of the discrete cavities may be in communication with the hollow space.

The support member may be a drum and the cutting elements may extend around at least a part of a circumference of the drum.

The cutting elements may be disposed continuously around the circumference of the drum.

In some embodiments the drum may be a rotary drum.

The support member may comprise at least one flat surface and the cutting elements may extend across the at least one flat surface.

According to an embodiment of the present disclosure there is provided an apparatus for cutting a sheet of dough which may comprise a cutting tool as described above and may further comprise a vacuum member, which may comprise a waste dough inlet in communication with the waste dough extraction path which may extract waste dough into the vacuum member.

The vacuum member may comprise a waste dough outlet in communication with the waste dough inlet for extracting waste dough through and out of the vacuum member.

The apparatus may further comprise a cyclone in communication with the waste dough outlet of the vacuum member such that extracted waste dough is collected in the cyclone to be re-used or disposed of.

The cyclone may further comprise an outlet and an auger disposed centrally within the outlet, wherein the auger may be rotatable to force waste dough collected in the cyclone through the outlet.

The vacuum member may comprise a first end and a second end disposed opposite to the first end, wherein the waste dough outlet may be provided at the first or second end of the vacuum member.

The support member may comprise a first end and a second end, wherein the first end and the second end of the support member may be disposed closer to the first end and the second end of the vacuum member 28, than a first end and a second end of the cutting tool respectively.

The vacuum member may be disposed within a hollow space which may be defined at least partially by the support member or the cutting elements.

In some embodiments the vacuum member and the cutting tool and/or the support member may share a longitudinal central axis.

In some embodiments the vacuum member may be a stationary component and the support member and/or the cutting tool may be configured to rotate around the vacuum member.

The waste dough inlet may be an elongate slot extending over more than half of a length of the vacuum member.

The waste dough inlet may be an elongate slot extending across substantially a full length of the vacuum member.

The waste dough inlet may comprise a plurality of apertures across a length of the vacuum member.

According to an embodiment of the present disclosure there is provided a method for cutting a sheet of dough comprising: positioning the cutting tool adjacent to a sheet of dough to be cut, such that the cutting edges are disposed towards the sheet of dough; cutting a sheet of dough, wherein each cutting element cuts a dough portion from the sheet of dough leaving discrete portions of waste dough between the dough portions; extracting the discrete portions of waste dough into the vacuum member through the waste dough extraction path and the waste dough inlet.

In some embodiments the cutting step may further comprise rolling the rotary drum and the cutting elements across the sheet of dough, wherein each cutting element may cut a dough portion from the sheet of dough which may leave discrete portions of waste dough between the dough portions.

In some embodiments the method may further comprise extracting dough from the vacuum member through the waste dough outlet to the cyclone.

In some embodiments the method may further comprise adding waste dough from the cyclone to virgin dough to form a new dough; rolling the new dough into a sheet of dough to be cut and may comprise repeating the method as described above.

### BRIEF DESCRIPTION OF THE DRAWINGS

One or more embodiments of the invention will now be described, by way of example only, with reference to the accompanying drawings, in which:

FIG. 1 shows a front view of a cutting apparatus comprising a cutting tool according to a first embodiment of the invention;

FIG. 2 shows a perspective cross sectional view of the cutting apparatus of FIG. 1 taken through axis S-S;

FIG. 3 shows a perspective view of the cutting apparatus of FIG. 1 whilst cutting a sheet of dough;

FIG. 4a shows a cross sectional front view of the cutting apparatus of FIG. 1 illustrating the internal configuration of the vacuum member;

FIG. 4b shows a schematic cross sectional front view of the cyclone shown schematically in FIG. 4a;

FIG. 5 shows a cross sectional side view of the cutting apparatus of FIG. 4 taken through axis E-E;

FIGS. 6a to 6e show schematic diagrams of a sheet of dough comprising dough portions and waste dough pieces which can be cut by the cutting tool;

FIG. 7 shows a perspective cross sectional view of a cutting tool of a second embodiment of the invention wherein the cutting elements do not comprise a base;

FIG. 8 shows a perspective cross sectional view of the cutting apparatus of a third embodiment of the invention wherein the cutting apparatus does not comprise a support member;

FIG. 9 shows a schematic diagram of a cutting tool according to a fourth embodiment of the invention wherein the cutting tool comprises a flat portion;

FIG. 10 shows a schematic diagram of a cutting tool according to a fifth embodiment of the invention, wherein the vacuum member comprises a flat portion and a hollow space.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

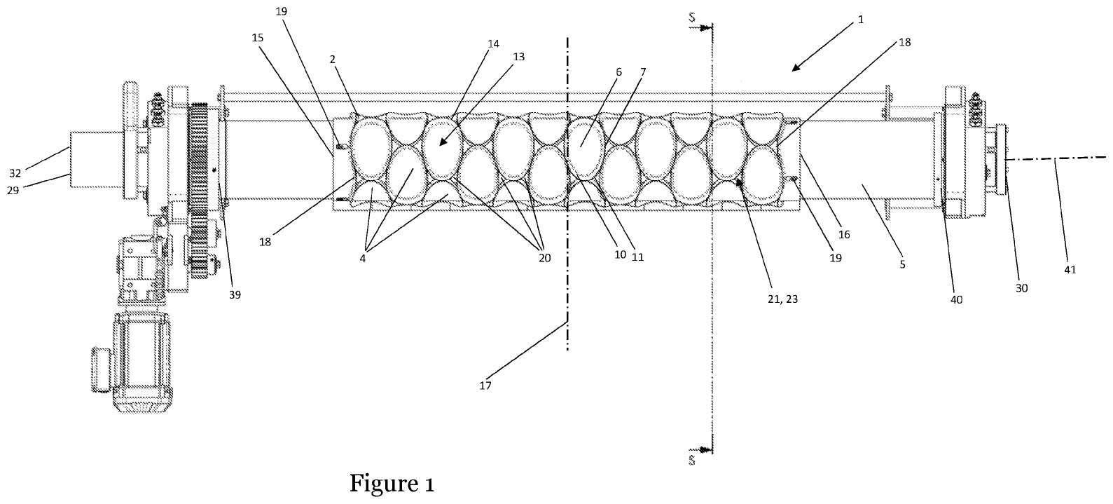

A cutting tool 2 according to a first embodiment is described herein with reference to FIGS. 1 to 5.

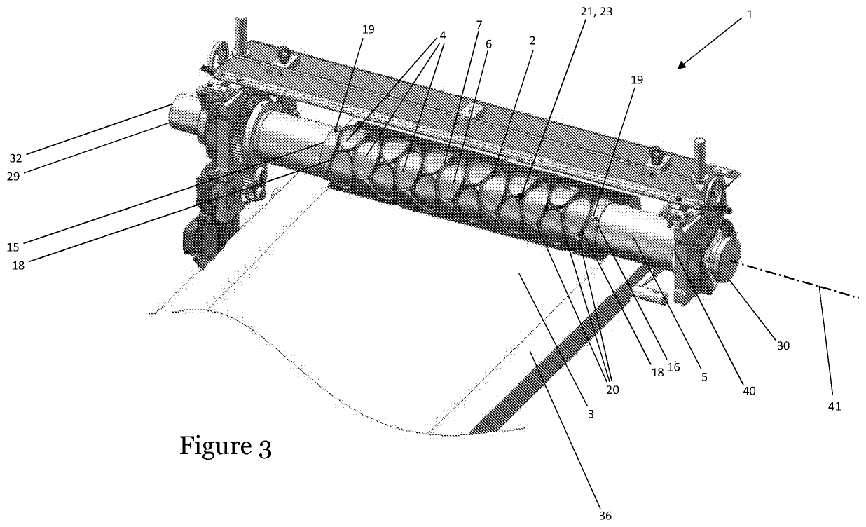

FIG. 1 shows a cutting apparatus 1 comprising a cutting tool 2 for cutting a sheet of dough 3 (shown best in FIG. 3). The cutting tool 2 comprises a plurality of cutting elements 4 arranged such that each cutting element 4 meets at least one adjacent cutting element 4. The cutting elements 4 are mounted on a support member 5. The support member 5 of the first embodiment is a drum.

Each cutting element 4 comprises a base 6 and a cutting edge 7 extending away from the respective base 6. The cutting elements 4 are rounded in shape, for example circular or elliptical and preferably all of the cutting elements 4 are identical in shape and size.

The cutting elements 4 extend around at least a part of a circumference of the support member 5. Preferably the cutting elements 4 are disposed continuously around the circumference of the support member 5. Advantageously this enables a relatively long sheet of dough to be cut.

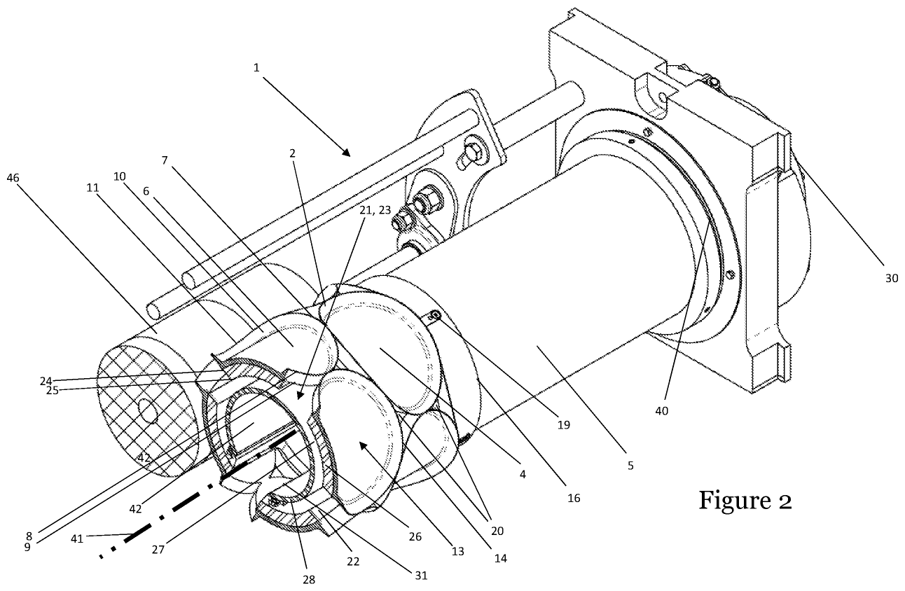

As illustrated best in FIG. 2, the cutting tool 2 comprises a top cutting surface 8 and a rear surface 9. The top cutting surface 8 is the face of the cutting tool 2 closest to the sheet of dough 3 in use. The rear surface 9 is the face of the cutting tool 2 opposite to the top cutting surface 8. The rear surface 9 is closest to the support member 5 when in use.

The cutting edge 7 comprises a wall 10 and a tip 11. The wall 10 extends from the tip 11 to the base 6. The wall 10 increases in thickness as it tends towards the rear surface 9, and reduces in thickness towards the tip 11. The bases 6 form the rear surface 9 of the cutting tool 2 according to the first embodiment. The tips 11 are provided at the cutting surface 8 and are configured to cut the sheet of dough 3. The tips 11 are sharp such that they are suitable for cutting through the sheet of dough 3 without ripping, tearing or damaging the dough.

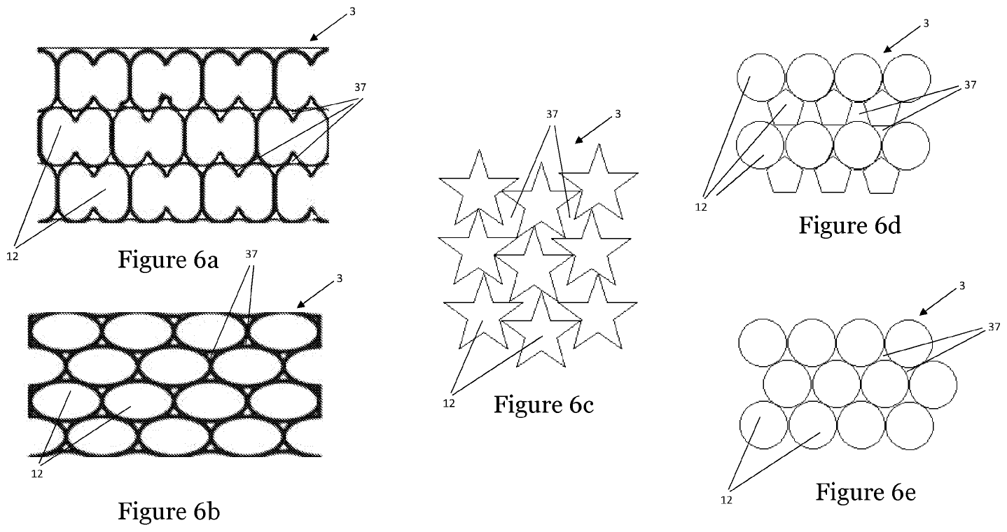

The cutting edge 7 of each cutting element 4 defines a closed shape such that the cutting tool 2 is configured to cut the sheet of dough 3 into separate dough portions 12 (examples of dough portions 12 are shown in FIGS. 6a to 6e). The cutting edge 7 extends around a perimeter of each respective base 6. The closed cutting edge 7 and the base 6 together form a cup shape having a pocket of space 13 at least partially enclosed by the cutting edge 7 and the base 6. The pocket of space 13 comprises an opening 14, which is bordered by the tip 11 of the cutting edge 7. The opening 14 of the pocket 13 is configured to face away from the support member 5 and towards the sheet of dough 3 in use.

The base 6 of the first embodiment is solid to prevent communication between the pocket 13 of the cutting elements 4 and the support member 5. This protects the dough portion 12 located within the pocket 13, as the dough portion 12 is being cut.

The base 6 comprises a consistent thickness and is shaped to closely fit to the shape of the support member 5. For example, the support member 5 of the first embodiment is a drum, therefore the base 6 of the cutting element 4 is curved to suit the circumference of the drum.

The cutting tool 2 further comprises a cleaning element 46, shown best in FIG. 2. The cleaning element 46 is disposed adjacent to the cutting edge 18 such that it can continuously keep the cutting edges 18 clean and free from any contaminants, such as residual dough from a previous cut.

Advantageously cleaning the cutting edge 18 improves the efficiency of the cutting process. This is because the tip 11 contacts the sheet of dough 3 without any obstruction, which therefore provides a more reliable and efficient cut of the sheet of dough. If the cutting edge 18 isn't clean then there is a risk of ripping or tearing the sheet of dough 3 as it is cut, or not entirely cutting the dough portion 12 as intended. This can result in faulty products and therefore higher wastage.

The cleaning element 46 may comprise, for example but not limited to, a brush, a foam, a sponge or a series of flexible or rigid bristles or protrusions. It can be appreciated that alternative known means for cleaning a cutting tool 2 can be envisaged.

The cutting tool 2 comprises a first end 15 and a second end 16. The first end 15 is disposed oppositely to the second end 16. As shown in FIG. 1, the first end 15 is provided in a plane which is substantially parallel to the plane of the second end 16. As illustrated in FIG. 1, the first end 15 is symmetrical to the second end 16, about a central axis 17 of the cutting tool 2. Each of the first end 15 and the second end 16 comprises a peripheral cutting edge 18 that meets the cutting elements 4 disposed closest to the first edge 15 and the second edge 16. The peripheral cutting edge 18 extends along the majority of the first end 15 and the second end 16. As illustrated in FIG. 1, where the support member 5 is a drum, and the cutting elements 4 are continuous around the circumference of the drum, the peripheral cutting edge 18 is also continuous around the circumference of each of the first end 15 and the second end 16.

The cutting edges 7 are continuous across the cutting tool 2, from the cutting edge 18 at the first end 15 to the cutting edge 18 at the second end 16. In some embodiments adjacent cutting elements 4 share a portion of the same cutting edge 7. In some embodiments where cutting elements 4 share a portion of the cutting edge 7, the cutting edge 7 of each cutting element may comprise a consistent thickness across the cutting tool 2.

In some embodiments the first end 15 and the second end 16 comprise mounting means 19 for mounting the cutting tool 2 to the support member 5.

Adjacent cutting elements 4 meet to define discrete cavities 20 between the cutting edges 7 of adjacent cutting elements 4. In the embodiment shown and described with reference to FIGS. 1 to 5, the majority of the discrete cavities 20 are defined by the cutting edges 7 of three cutting elements 4 which meet to form a closed shape therebetween. The discrete cavities 20 located closest to the first end 15 and the second end 16 respectively are defined by the cutting edges 7 of two cutting elements 4 and the peripheral cutting edge 18.

The discrete cavities 20 provide a first extraction path 21 through the cutting tool 2. The first extraction path 21 extends from the top surface 8 to the rear surface 9 of the cutting tool 2.

In some embodiments the cutting tool 2 is a single component, in which all the cutting elements 4 are integral with one another.

As shown best in FIG. 2, the support member 5 comprises at least one aperture 22 extending therethrough, preferably the support member 5 comprises a plurality of apertures 22. The plurality of apertures 22 provide a second extraction path 23, from an external surface 24 to an internal surface 25 of the support member 5. The external surface 24 and internal surface 25 are part of an outer wall 26 that at least partially surrounds a hollow space 27. The plurality of apertures 22 extend through the outer wall 26 such that each of the discrete cavities 20 is in communication with the hollow space 27.

Each discrete cavity 20 of the cutting tool 2 is in communication with at least one aperture 22 of the support member 5. Therefore, the first extraction path 21 is in communication with the second extraction path 22, providing a waste dough extraction path from the top cutting surface 8 of the cutting tool 2 to the internal surface 24 of the support member 5.

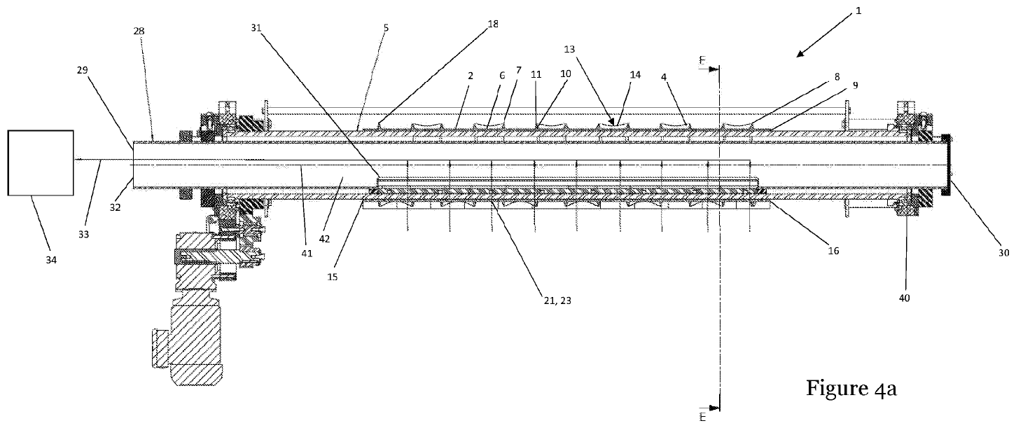

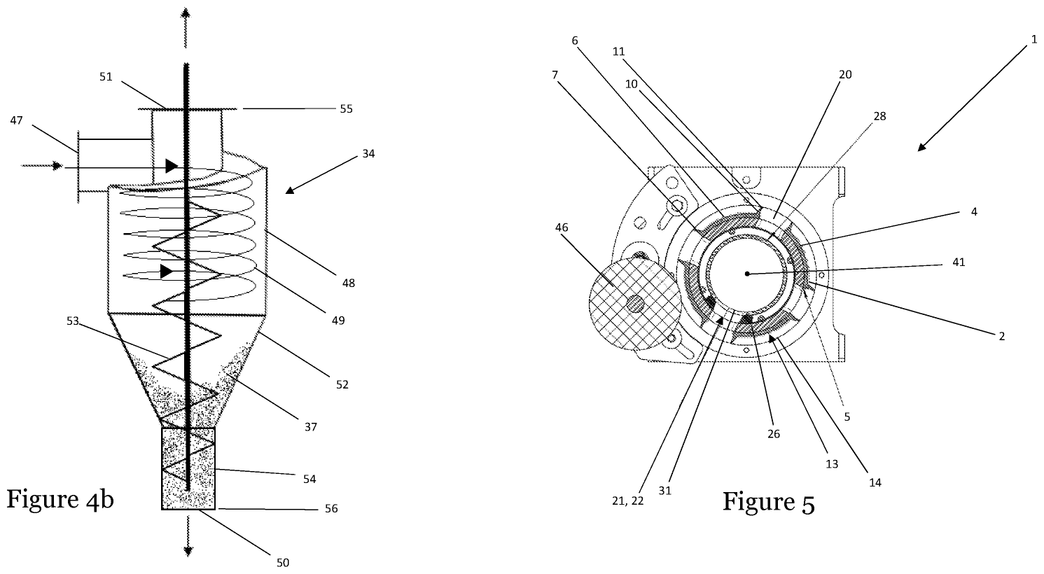

As shown best in FIG. 4a the cutting apparatus 1 further comprises a vacuum member 28. The vacuum member 28 is disposed within the hollow space 27 of the support member 5. Preferably the vacuum member 28 and the support member 5 share the same longitudinal central axis 41, such that the vacuum member 28 is disposed centrally within the hollow space 27 of the support member 5. The vacuum member 28 also comprises a hollow space 42 within.

As mentioned above in reference to FIG. 1, the support member 5 of the first embodiment is a drum, particularly a rotary drum. The support member 5 rotates about the longitudinal central axis 41. The vacuum member 28 is configured to be a stationary component and the support member 5 rotates around the vacuum member 28.

The vacuum member 28 comprises a first end 29 and a second end 30. The first end 29 is disposed oppositely to the second end 30. In use, the first end 15 of the cutting tool 2 is disposed towards the first end 29 of the vacuum member 28 and the second end 16 of the cutting tool 2 is disposed towards the second end 30 of the vacuum member 28.

The support member 5 comprises a first end 39 and a second end 40, wherein the first end 39 and the second end 40 of the support member 5 are disposed closer to the first end 29 and the second end 30 of the vacuum member 28, than the first end 15 and the second end 16 of the cutting tool respectively.

The vacuum member 28 comprises at least one waste dough inlet 31 and at least one waste dough outlet 32. A third extraction path 33 (shown in FIG. 4a) is provided from the waste dough inlet 31, through the vacuum member 28 and through the waste dough outlet 32 and out of the vacuum member 28. The waste dough inlet 31 is in communication with the waste dough extraction path, comprising the first extraction path 21 and the second extraction path 23.

As illustrated in FIG. 4a, the waste dough outlet 32 is provided at the first end 29 or the second end 30 of the vacuum member 28, for the ease of extraction of waste dough away from the vacuum member 28. Optionally an adjustable air flow (not shown) may be provided through the other of the first end 29 and the second end 3o, opposite to the waste dough outlet 32, to keep the waste dough pieces 37 airborne and flowing through the vacuum member 28.

The waste dough inlet 31 of the first embodiment is an elongate slot extending over more than half a length of the vacuum member 28. Alternatively the waste dough inlet 31 can be a plurality of apertures across a length of the vacuum member 28, more than one slot, or an elongate slot extending across substantially a full length of the vacuum member.

One method of generating a vacuum in the vacuum member 28 is by means of a is centrifugal fan mounted on a cyclone 34 (shown diagrammatically in FIG. 4a and illustrated in more detail in FIG. 4b). In such an embodiment, the cutting apparatus 1 further comprises a cyclone 34. Waste dough pieces 37 are extracted through the waste dough extraction path 21, 23 and the third extraction path 33, to the cyclone 34, for further processing, re-use or disposal.

FIG. 4b shows the cyclone 34 in more detail. The waste dough pieces 37 enter the cyclone through the cyclone inlet 47, which leads to a substantially cylindrical cyclone chamber 48. A vortex 49 is created in the cyclone chamber 48 which comprises a helical airflow, initially including the waste dough pieces 37, from the cyclone inlet 47 in a direction towards a cyclone waste dough outlet 50 at the bottom 56.

As the waste dough pieces 37 are larger and denser than the particles of air, the waste dough pieces 37 drop out of the vortex of the cyclone 34 and into a cone area 52. As the waste dough pieces 37 drop out of the vortex 49, the air exits the cyclone 34 through the centre of the cyclone 34 in a direction towards an air outlet 51 disposed on a top 55 of the cyclone 34.

At a predetermined time the waste dough pieces 37 can then be ejected from the cone area 52, through the cyclone waste dough outlet 50 and transported to a mixer for re-use. Alternatively the waste dough pieces 37 can be ejected through the cyclone waste dough outlet 50 and transported for disposal.

The waste dough pieces 37 are assisted in being ejected from the cyclone 34 by an auger or screw 53 disposed centrally within the cyclone 34. The cyclone waste dough outlet 50 comprises a cylindrical neck 54, and the auger 53 is sized to fit within the neck 54. As the auger 53 is rotated, it forces the waste dough 37 downwards through the neck 54 and out through the cyclone waste dough outlet 50 for re-use or disposal. Advantageously the auger 53 being sized to fit the neck 54 ensures waste dough 37 does not build up at the cyclone waste dough outlet 50.

A method of cutting the sheet of dough 3, using the cutting apparatus 1, will now be described with reference to FIGS. 1 to 5.

The sheet of dough 3 is conveyed on a conveyor 36 towards the cutting tool 2. The cutting tool 2 is positioned adjacent to the sheet of dough 3 to be cut, arranged such that the cutting edges 7 are disposed towards the sheet of dough 3 in use and contact the conveyor 36 at their closest point to the conveyor 36. In the preferred embodiment shown, the cutting edges 7 have a depth greater than the thickness of the sheet of dough 3, so that the cutting elements 4 cut entirely through the sheet of dough 3, which helps to avoid the sheet of dough coming into contact with, or sticking to, the base 6 of the cutting elements. If the cutting edges have a depth less than the thickness of the sheet of dough, then the dough may stick to other parts of the cutting apparatus 1, which can damage the dough portions 12, or the cutting edges 7 may not cut entirely through the sheet of dough 3 and therefore the waste dough pieces 37 for removal may remain attached to the dough portions 12 and cannot be removed. In an alternative arrangement, however, it is envisaged that the cutting edges 7 may have a depth less than the thickness of the sheet of dough 3, so that although the cutting elements 4 cut entirely through the sheet of dough 3 the dough may be compressed during cutting, in processes where such manipulation of the dough may be desirable.

The cutting tool 2 is rotated around the longitudinal axis 41 to cut the sheet of dough 3. As the cutting tool 2 is fixed to the support member 5 by the mounting means 19, both the cutting tool 2 and the support member 5 rotate together, to continuously cut the sheet of dough 3 into portions 12, as the sheet of dough 3 is conveyed past the cutting tool 2. The cutting tool 2 is rolled across the sheet of dough 3, in the direction of the travel of the conveyor 36, to cut it into portions 12. The direction of travel is defined as the direction at which the point of the cutting tool 2 closest to the sheet of dough is moving. The cutting tool 2 and the support member 5 are rotationally fixed relative to one other during the cutting action.

As shown best in FIG. 6b, as each cutting element 4 cuts a dough portion 12 from the sheet of dough 3, discrete pieces of waste dough 37 are formed between adjacent dough portions 12. Traditionally the waste dough would be formed in a single sheet from which the dough portions 12 had been cut and removed, rather than discrete portions, which can then be lifted, pulled or conveyed away from the conveyor 36 and/or the dough portions 12 in a continuous manner. This method of removal does not work with discrete pieces of waste dough 37.

As the dough portions 12 are cut, and substantially surrounded by the cutting elements 4, the discrete portions of waste dough 37 are aligned with the discrete cavities 20 of the cutting tool 2. Suction is applied through the vacuum member 28 which extracts the discrete pieces of waste dough 37, through the discrete cavities 20, through the waste dough extraction path 21, 23 and into the vacuum member 28.

Although the cutting tool 2 and the support member 5 rotate as the cutting elements 4 cut the sheet of dough 3, the vacuum member 28 remains stationary. This is so that suction is applied only to the discrete cavities 20 that are aligned with the portions of waste dough 37, which can increase the efficiency of the cutting apparatus 1. As the vacuum member 28 is stationary in use, the waste dough inlet 32 remains directed towards the sheet of dough 3 throughout the cutting process, even when the cutting tool 2 and support member 5 are rotating. The waste dough inlet 32, is therefore in communication with only some of the discrete cavities 20 at any one time. Particularly, those discrete cavities 20 with which at the time, are aligned with the discrete waste dough pieces 37.

In some embodiments, for example as illustrated in FIGS. 1 to 5, where the cutting elements comprise a base 6 and the waste dough inlet 31 is a slot, the base 6 prevents suction from the vacuum member 28 from being applied to the dough portions 12. This helps to prevent any part of the dough portions 12 from accidentally being extracted. It can be appreciated that there are alternative configurations of the vacuum member 28 in which the base 6 may prevent suction from being applied to the dough portions 12 intended within the scope of the present disclosure.

The waste dough pieces 37 can then be extracted from the vacuum member 28 through the waste dough outlet 32 for further processing. In some embodiments the waste dough 37 is extracted to the cyclone 34 which prepares the waste dough 37 for further processing.

Further processing can be for disposal, adding to virgin dough to form a new dough, or re-using the dough. Where the waste dough 37 is re-used either by combining with virgin dough to form a new dough, or to directly re-use the waste dough, it is rolled into a sheet of dough to be cut 3 and the method described above can be repeated.

FIGS. 6a to 6e show examples of cut sheets of dough 3, comprising discrete dough portions 12 and waste dough pieces 37 for extraction. It can be appreciated that there are a great number of different configurations for the cutting elements 4 of a cutting tool. The particular shapes and sizes of the dough portions 12 and waste dough pieces 37 will depend on a user's requirements.

Advantageously the cutting tool creating waste dough pieces 37 which are discrete from one another, as opposed to leaving a sheet of waste dough once the portions 12 have been cut, significantly reduces the overall wastage from the cutting process. This maximises the efficiency of the dough usage. Typically this also provides a more efficient and less costly bread making process as a larger number of breads can be cut from a single sheet of dough and in a specific time period, increasing the throughput of the process.

Advantageously having waste dough pieces 37 instead of a sheet of waste dough also minimises the amount of re-worked dough. This is important as re-worked dough can become tougher than virgin dough. Therefore it is preferable that only a small amount of waste dough 37 is added to virgin dough for re-use, to improve the quality of the overall product. Virgin dough is dough which has not been re-worked.

Furthermore dough can become overworked and not suitable for use if it is handled too much. As the sheet of dough 3 travels through the manufacturing process including the cutting process, due to the linear nature of most manufacturing processes, gluten in the dough can begin to align. This can cause stress in the dough and can result in a tougher dough than desired. The handling of the dough throughout the manufacturing process, including the cutting process, is therefore intended to be minimal.

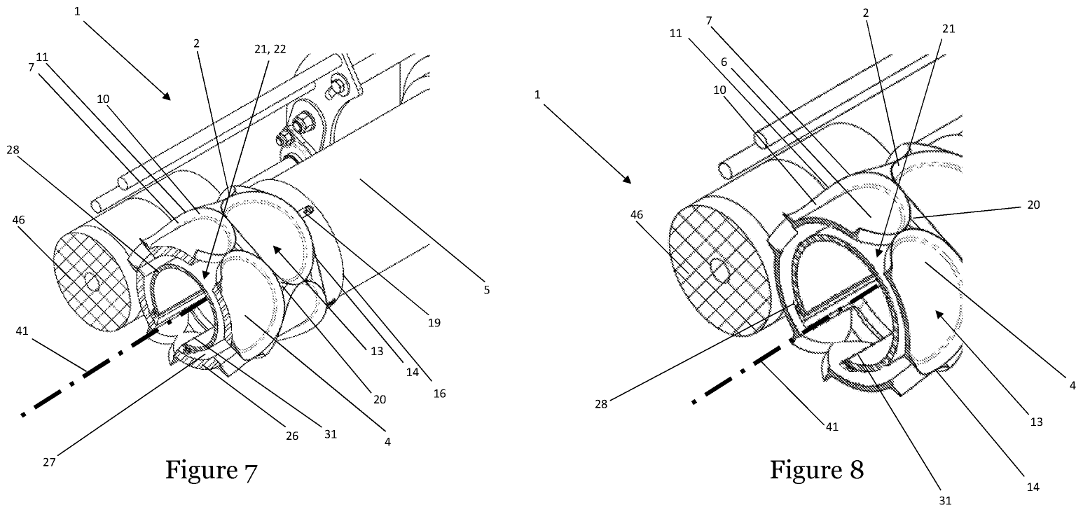

FIG. 7 shows a cutting tool 2 of a second embodiment. The cutting tool 2 has similar features to the cutting tool 2 of the first embodiment described above in relation to FIGS. 1 to 5, with like features retaining the same reference numerals. A difference is that the cutting elements 4 of the cutting tool 2 do not comprise a base 6.

The cutting tool 2 is configured as a substantially cylindrical component and the cutting edges 7 extend substantially radially outwardly from a central axis 41 of the cylindrical component. The cutting of the sheet of dough 3 into dough portions 12 is the same as described above in relation to previous embodiments. The sheet of dough 3 is cut by the cutting edges 7. In this second embodiment, the apertures 22 of the support member 5 are located directly over the discrete cavities 20 of the cutting tool 2, and not over the cutting elements 4. This prevents suction from being applied to the dough portions 12 as they are cut by the cutting element 4. Preferably the cutting tool 2 is configured to be proximate to the support member 5 when the apparatus 1 is assembled, such that the support member 5 serves as a closed base of each cutting element 4.

Advantageously the cutting tool 2 not comprising a base 6 means that the cutting tool 2 comprises less material than a cutting tool 2 with a base 6. This typically means that the cutting tool 2 is cheaper to manufacture and results in a lighter cutting tool 2. A lighter cutting tool 2 typically means that the support member 5 may also be lighter, as well as other components of the apparatus 1.

FIG. 8 shows a cutting apparatus 1 of a third embodiment. The cutting apparatus 1 has similar features to the cutting apparatus 1 of the first embodiment described above in relation to FIGS. 1 to 5, or the second embodiment described in relation to FIG. 7, with like features retaining the same reference numerals. A difference is that the cutting apparatus 1 does not comprise a support member 5.

In this embodiment the discrete cavities 20 of the cutting tool 2 are in communication with the vacuum member 28 and the cutting action is the same as described in reference to the first and second embodiments. There is no second extraction path 23, the waste dough pieces 37 are removed through the first extraction path 21 and through the waste dough inlet 31 of the vacuum member 28. Optionally, the cutting tool 2 is mounted on the vacuum member 28. Alternatively the cutting tool 2 is mounted on another part of the apparatus 1.

In some embodiments the cutting tool 2 is mounted on the vacuum member 28 such that the cutting tool 2 can still rotate around a stationary vacuum member 28. The mounting means may be, for example but not limited to, a ball or roller bearing mounting means.

In alternative embodiments the vacuum member also rotates with the cutting tool 2 and comprises a plurality of waste dough inlets 31. In this embodiment each discrete cavity 20 is in continuous communication with at least one waste dough inlet 31 throughout a full rotation of 360 degrees.

Advantageously the cutting apparatus 1 not comprising a support member 5 means that the apparatus 1 comprises fewer components. This typically means that assembly of the apparatus 1 is simpler. The cutting tool 2 of this embodiment can also be an entirely unitary component, which can also result in a cutting tool 2 which is quicker and easier to manufacture.

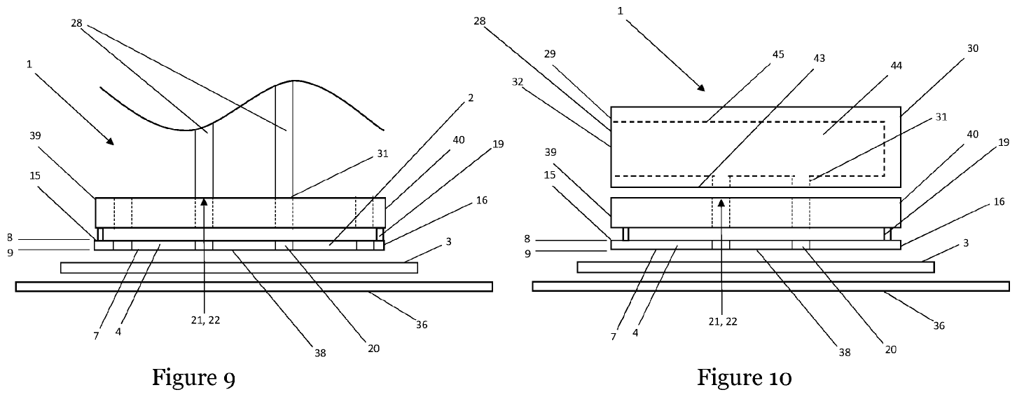

FIG. 9 shows a cutting apparatus 1 of a fourth embodiment. The cutting apparatus 1 has similar features to the cutting apparatus 1 of the embodiments described above in relation to FIGS. 1 to 8, with like features retaining the same reference numerals. A difference is that the cutting tool 2 and/or the support member 5 comprise at least one flat surface 38, and the cutting elements 4 extend across the at least one flat surface 38.

Optionally the vacuum member 28 may comprise a series of vacuum tubes, preferably each discrete cavity 20 of the cutting tool 2 is in communication with a single vacuum tube. It can be appreciated that the cutting apparatus 1 of the fourth embodiment is compatible with other configurations of vacuum member 28 described herein, and the vacuum tubes 28 are compatible with other cutting tools 2 described herein

In this embodiment, the cutting tool 2 is lifted and moved to a new position each time it cuts a section of dough portions 12. The cutting action is a stamping action, as opposed to the rolling cutting action described in relation to the cutting tool 2 of the first embodiment. In some embodiments the flat surface 38 is a similar size to the sheet of dough 3 to be cut, and therefore a single stamping action is sufficient to cut the sheet of dough 3 into dough portions 12. Alternatively the cutting tool 2 may firstly stamp a first section of the sheet of dough 3. Secondly, the cut first section of dough 3 is then conveyed past the cutting tool 2 until a next section of the sheet of dough 3 is aligned with the cutting elements 4 of the cutting tool 2 to be stamped. The next section of the sheet of dough 3 is then stamped and the conveying and stamping process is repeated.

In any of the embodiments in which the cutting tool 2 cuts the sheet of dough 3 by stamping, as the cutting tool 2 is stamping the sheet of dough 3, both the dough 3 and the cutting tool 2 may also be conveyed in the same direction. Advantageously this means that the sheet of dough 3 is continuously conveyed throughout the cutting process and the conveyor does not need to stop and start.

FIG. 10 shows a cutting apparatus 1 of a fifth embodiment. The cutting apparatus 1 has similar features to the cutting apparatus 1 of the fourth embodiment described above in relation to FIG. 9, with like features retaining the same reference numerals. A difference is that the vacuum member 28 also comprises at least one flat surface 43.

In some embodiments the vacuum member 28 also comprises a hollow space 44. The waste dough removal process is similar to other embodiments described herein. As the dough portions 12 are cut, and substantially surrounded by the cutting elements 4, the discrete portions of waste dough 37 are aligned with the discrete cavities 20 of the cutting tool 2. Suction is produced in the hollow space 44 and applied through the vacuum member 28 which extracts the discrete pieces of waste dough 37, through the discrete cavities 20, and through the waste dough extraction path 21, 23. The waste dough 37 is then drawn into the vacuum member 28, through the waste dough inlet 31 into the hollow space 44 and through the waste dough outlet 32. The cutting action may be similar to the stamping action described in relation to the fourth embodiment.

Advantageously this provides a more compact apparatus 1 whilst retaining the hollow space 44 for producing the suction to extract the waste dough 37. The hollow space 44 also provides a larger area for the waste dough 37 to be extracted into, reducing the risk of it touching or sticking to any inner walls 45 of the vacuum member as the waste dough 37 is extracted.

In the above described embodiments, where the term hollow space is used this is intended to mean a space which is substantially enclosed to waste dough, the hollow space is preferably open to waste dough only at the waste dough inlet 31, and where appropriate the waste dough outlet 32. In some embodiments the area of hollow space that is open comprises less than half of the total enclosed hollow space. In other embodiments the area of hollow space that is open comprises less than 10% to 30% of the total enclosed hollow space. In some embodiments the hollow space has a cross sectional area greater than the waste dough inlet 31 and/or the waste dough outlet 32.

It can be appreciated that compatible features of the above described embodiments can be combined and substituted to form a cutting apparatus 1 that falls within the scope of the present disclosure.

Many variants of the example embodiments are described above and discussed below. The skilled person will be aware of further variants and modifications that may be made to the embodiments described herein.

In the above described embodiments the cutting apparatus 1 comprises a support member 5 and a vacuum member 28. However, in alternative embodiments intended within the scope of the present disclosure, the support member 5 and the vacuum member 28 are the same component.

In the above described embodiments the cutting elements 4 are mounted on a support member 5. However, in alternative embodiments intended within the scope of the present disclosure, the cutting elements 4 may be mounted on an intermediate or alternative component and the cutting elements 4 are merely supported by the support member 5, and not mounted directly to the support member 4.

In the above described embodiments the cutting elements 4 are mounted on a support member 5. However, in alternative embodiments intended within the scope of the present disclosure, the cutting elements 4 and the support member 5 are integral with one another.

In the above described embodiments the cutting elements 4 are rounded in shape, for example circular or elliptical. However, in alternative embodiments intended within the scope of the present disclosure, the cutting elements 4 can be quadrilateral, polygonal or triangular in shape.

In the above described embodiments the cutting elements 4 are identical in shape. However, in alternative embodiments intended within the scope of the present disclosure, the cutting elements 4 are not identical in shape, but comprise a combination of different shapes to form discrete cavities therebetween.

In the above described embodiments each cutting element 4 comprises a base 6 and a cutting edge 7 extending away from the base 6. However, in alternative embodiments intended within the scope of the present disclosure, each cutting element 4 does not comprise a base 6 and instead the cutting edge 7 extends away from the support member 5. The cutting edge 7 forms a plurality of discrete secondary apertures from the sheet of dough to the support member 4 in place of the pocket 13 of the embodiments illustrated and described above.

In the above described embodiments the base 6 is solid. However, in alternative embodiments intended within the scope of the present disclosure, the base 6 can be a mesh, a grid or comprise apertures. The base 6 may comprise protrusions or formations. The configuration of the base may be to prevent suction forming in the pockets 13 which could lead to the dough portion 12 being retained within the cutting element 4.

In the above described embodiments the wall 10 of the cutting edge 7 extends from the tip 11 to the base 6. However, in some embodiments where the cutting elements 4 do not comprise a base 6, the wall 10 extends from the tip 11 to the rear surface 9.

In the above described embodiments the wall 10 increases in thickness as it tends towards the rear surface 9, and reduces in thickness towards the tip 11. However, in alternative embodiments intended within the scope of the present disclosure, the wall 10 may be a consistent thickness from the tip 11 to the base, or comprise a thick portion and a thin portion.

In the above described embodiments the opening 14 is configured to face away from the support member 5 in use. However, in embodiments in which there is no support member 5, an alternative way of describing the configuration of the opening 14 is that the opening 14 is configured to face away from the rear surface 9 of the cutting tool 2.

In the above described embodiments the first end 15 is provided in a plane which is substantially parallel to the plane of the second end 16. However, in alternative embodiments intended within the scope of the present disclosure, the first end 15 may be provided in a plane that is not parallel to the plane of the second end 16.

In the above described embodiments the first end 15 is symmetrical to the second end 16, about a central axis of the cutting tool 2. However, it can be appreciated that other configurations of the cutting tool 2 can be envisaged in which the first end and the second end are configured differently to one another.

In the above described embodiments each of the first end 15 and the second end 16 comprises a peripheral cutting edge 18 that meets the cutting elements 4 disposed closest to the first edge 15 and the second edge 16. However, in alternative embodiments intended within the scope of the present disclosure, the plurality of cutting elements 4 are disposed past each edge of the sheet of dough 3, in a direction towards both the first end 15 and the second end 16 respectively, such that the peripheral cutting edge 18 is not required.

In the above described embodiments the base 6 comprises a consistent thickness. However, in alternative embodiments intended within the scope of the present disclosure, the base 6 may comprise a variable thickness or comprise protrusions and/or grooves on a surface of the base, to assist in preventing the dough from sticking or being retained inside the pocket 13 of the cutting element 4.

In the above described embodiments the base 6 is shaped to closely fit to the shape of the support member 5. However, it can be appreciated that the base 6 of each cutting element 4 may be linear and not curved, even when mounted on a curved support member 5, and would still work in the same way.

In the above described embodiments the cutting elements 4 are integral with one another such that all the cutting elements 4 form a single or unitary component. However, in alternative embodiments intended within the scope of the present disclosure, each cutting element 4 is a separate element, or may be formed in groups of cutting elements connected together or disposed adjacent one another. In some embodiments the groups are integral and connected to or disposed adjacent to at least one other group or cutting element. In some embodiments, each cutting element 4 is integral with at least one other cutting element 4.

In the above described embodiments the cutting tool 2 is rolled in the direction of the travel of the conveyor 36, to cut the sheet of dough 3 into dough portions 12. However, in alternative embodiments intended within the scope of the present disclosure, the sheet of dough 3 is stationary and the cutting tool 2 is rolled along the sheet of dough 3 to cut it into dough portions 12.

In the above described embodiments the vacuum member 28 is stationary in use and the waste dough inlet 32 remains directed towards the sheet of dough 3 throughout the cutting process. However, in alternative embodiments intended within the scope of the present disclosure, each discrete cavity 20 is continuously aligned with one or more waste dough inlet(s) 31. In some embodiments, each discrete cavity 20 is aligned with a single and separate waste dough inlet 31, for example, in some embodiments the number of discrete cavities 20 is equal to the number of waste dough inlets 31.

In the above described embodiments the vacuum member 28 is stationary in use. However, in alternative embodiments intended within the scope of the present disclosure, the vacuum member 28 is rotatable. In some embodiments the vacuum member 28 is rotatable with the cutting tool 2 and/or the support member 5.

In the above described embodiments the first end 39 and the second end 40 of the support member 5 are disposed closer to the first end 29 and the second end 30 of the vacuum member 28, than the first end 15 and the second end 16 of the cutting tool respectively. In some embodiments intended within the scope of the present invention, the first end 39 and the second end 40 of the support member 5 are aligned with the first end 29 and the second end 30 of the vacuum member 28.

In some of the above described embodiments, where the cutting tool 2 does not comprise a base 6, the cutting tool 2 is configured to be proximate to the support member 5 when the apparatus 1 is assembled, such that the support member 5 serves as a closed base of each cutting element 4. However, in alternative embodiments intended within the scope of the present disclosure, the vacuum member 28 can serve as a closed base of each cutting element 4 where the apparatus 1 does not comprise a support member 5.

In some embodiments the term cutting tool 2 is intended to mean comprising the support member 5 and the cutting elements 4. In other embodiments the term cutting tool 2 is intended to mean comprising the cutting elements 4 and not the support member 5.

All of the above described features in relation to a cylindrical cutting tool 2, support member 5 and vacuum member 28 also apply to a flat, or polygonal shaped cutting tool 2, support member 5 or vacuum member 28. For example, the support member of the fifth embodiment may comprise a hollow 27 within the outer wall 26, the vacuum member 28 being disposed within the hollow 27.

In the above described embodiments the vacuum member 28 comprises a waste dough inlet 31 and a waste dough outlet 32. However, in some embodiments there is no waste dough outlet 32 and waste dough 37 is stored in the vacuum member 28 and removed as a separate process.

In the above described embodiments the cutting tool 2 comprises a cleaning element 46 to continuously keep the cutting edges 18 clean and free from any contaminants. However, in alternative embodiments intended within the scope of the present disclosure, the cleaning element 46 may be moveable such that it does not continuously keep the cutting edges clean, but periodically is moved adjacent to the cutting tool to clean the cutting edges 18. In some embodiments the cutting tool 2 does not comprise a cleaning element. In some embodiments the cleaning of the cutting edges 18 is done manually.

In the above described embodiments the adjustable air flow is provided at the end opposite to the waste dough outlet 32. However, in alternative embodiments intended within the scope of the present disclosure, the adjustable air flow may be provided at intervals along the vacuum member or may be provided at a location different to either the first end 29 or the second end 30.

In the above described embodiments the cyclone 34 comprises an auger 53 to assist in removal of the waste dough 37 from the cyclone 34. However, in alternative embodiments intended within the scope of the present disclosure, the cyclone 34 does not comprise an auger 53 and the waste dough 37 is manually removed from the cyclone waste dough outlet 50.

In the above described embodiments the cutting apparatus 1 is for cutting a sheet of dough 3. However, it can be appreciated that the cutting apparatus 1 may also be used for cutting cooked items for example biscuits, pastry or bread, or any other food stuffs from which waste dough is created between the cut portions.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

1-33. (canceled)

34. A cutting tool for an apparatus for cutting a sheet of dough, the cutting tool comprising:
a plurality of cutting elements, each cutting element comprising a cutting edge defining a closed shape,
wherein the cutting edges of adjacent cutting elements meet to define discrete cavities between the cutting edges of adjacent cutting elements.

35. A cutting tool for an apparatus for cutting a sheet of dough according to claim 34, further comprising a support member having a plurality of apertures extending therethrough, wherein each of the discrete cavities is in communication with at least one of the apertures in the support member to define a waste dough extraction path.

36. A cutting tool for an apparatus for cutting a sheet of dough according to claim 34, wherein each cutting element further comprises a base and the cutting edges extend from the respective base.

37. A cutting tool for an apparatus for cutting a sheet of dough according to claim 36, wherein each cutting edge extends around a perimeter of the respective base.

38. A cutting tool for an apparatus for cutting a sheet of dough according to claim 36, wherein the base and the cutting edges together define a pocket in the cutting element, wherein the base is configured to prevent communication between the apertures in the support member and the respective pockets of the cutting elements.

39. A cutting tool for an apparatus for cutting a sheet of dough according to claim 34, wherein adjacent cutting elements share a portion of the cutting edge such that the cutting edge of each cutting element comprises a consistent thickness.

40. A cutting tool for an apparatus for cutting a sheet of dough according to claim 34, wherein the cutting elements are integral such that all the cutting elements are formed from a single piece.

41. A cutting tool for an apparatus for cutting a sheet of dough according to claim 34, wherein the support member comprises an outer wall at least partially surrounding a hollow space, the plurality of apertures extend through the outer wall such that each of the discrete cavities is in communication with the hollow space.

42. A cutting tool for an apparatus for cutting a sheet of dough according to claim 34, wherein the support member is a drum and the cutting elements extend around at least a part of a circumference of the drum, and optionally the cutting elements are disposed continuously around the circumference of the drum.

43. A cutting tool for an apparatus for cutting a sheet of dough according to claim 34, wherein the support member comprises at least one flat surface and the cutting elements extend across the at least one flat surface.

44. An apparatus for cutting a sheet of dough comprising the cutting tool of claim 34, the apparatus further comprising:
a vacuum member comprising a waste dough inlet in communication with the discrete cavities to extract waste dough into the vacuum member.

45. An apparatus for cutting a sheet of dough according to claim 44, wherein the vacuum member comprises a waste dough outlet in communication with the waste dough inlet for extracting waste dough through and out of the vacuum member.

46. An apparatus for cutting a sheet of dough according to claim 45, further comprising a cyclone in communication with the waste dough outlet of the vacuum member such that extracted waste dough is collected in the cyclone to be re-used or disposed of.

47. An apparatus for cutting a sheet of dough according to claim 46, wherein the cyclone further comprises an outlet and an auger disposed centrally within the outlet, wherein the auger is rotatable to force waste dough collected in the cyclone through the outlet.

48. An apparatus for cutting a sheet of dough according to claim 45, wherein the vacuum member comprises a first end and a second end disposed opposite to the first end, wherein the waste dough outlet is provided at the first or second end of the vacuum member.

49. An apparatus for cutting a sheet of dough according to claim 48, wherein the support member comprises a first end and a second end, wherein the first end and the second end of the support member are disposed closer to the first end and the second end of the vacuum member, than a first end and a second end of the cutting tool respectively.

50. An apparatus for cutting a sheet of dough according to claim 44, wherein the vacuum member is disposed within a hollow space defined at least partially by the support member or the cutting elements.

51. An apparatus for cutting a sheet of dough according to claim 50, wherein at least one of the vacuum member and the cutting tool, or the support member share a longitudinal central axis.

52. An apparatus for cutting a sheet of dough according to claim 51, wherein the vacuum member is a stationary component and at least one of the support member or the cutting tool is configured to rotate around the vacuum member.

53. A method for cutting a sheet of dough using the apparatus of claim 44 comprising:
positioning the cutting tool adjacent to a sheet of dough to be cut, such that the cutting edges are disposed towards the sheet of dough;
cutting a sheet of dough, wherein each cutting element cuts a dough portion from the sheet of dough leaving discrete portions of waste dough between the dough portions; and
extracting the discrete portions of waste dough into the vacuum member through the waste dough extraction path and the waste dough inlet.
